(19) United States
(12) Patent Application Publication
(10) Pub. No.: US 2022/0316121 A1
(43) Pub. Date: Oct. 6, 2022

(54) Emblem Member

(71) Applicant: MIZUNO CORPORATION, Osaka (JP)

(72) Inventors: Masataka KOBAYASHI, Fukui (JP); Toshiaki NISHIMURA, Osaka (JP); Joji TAN, Osaka (JP)

(21) Appl. No.: 17/677,179

(22) Filed: Feb. 22, 2022

(30) Foreign Application Priority Data
Apr. 2, 2021 (JP) 2021-069549

(51) Int. Cl. D05C 17/00

(52) U.S. Cl. CPC D05C 17/00; D10B 2507/00; A63B 71/143

(57) ABSTRACT

An emblem member having a large degree of freedom in design can be obtained. The emblem member comprises a base portion, a mark portion, and a transparent member. The base portion has a surface. The mark portion is formed on a surface of the base portion. The transparent member is connected to the base portion so as to cover at least a portion of the mark portion. In this case, the mark portion can be visually recognized through the transparent member, and the transparent member can have a three-dimensional shape determined independently of the shape and material(s) of the mark portion. This can provide an increased degree of freedom in designing the emblem member.

This nonprovisional application is based on Japanese Patent Application No. 2021-063549 filed on Apr. 2, 2021 with the Japan Patent Office, the entire contents of which are hereby incorporated by reference.

### BACKGROUND OF THE INVENTION

### Field of the Invention

The present disclosure relates to an emblem member.

### Description of the Background Art

A conventionally known method employs three-dimensional embroidery in order to form a three-dimensional emblem member (for example, see Japanese Patent Laying-Open No. 3-249259). Japanese Patent Laying-Open No. 3-249259 discloses that a three-dimensional embroidery pattern is formed by introducing an elastic body inside a yarn constituting the embroidery pattern.

### SUMMARY OF THE INVENTION

In the above-described conventional method, it is difficult to significantly change the emblem member in terms of shape, tactile impression and the like, and there is a problem in that the method does not provide a large degree of freedom in design.

The present disclosure has been made in order to address such an issue as above, and an object of the present disclosure is to provide an emblem member having a large degree of freedom in design.

The presently disclosed emblem member comprises a base portion, a mark portion, and a transparent member. The base portion has a surface. The mark portion is formed on a surface of the base member. The transparent member is connected to the base portion so as to cover at least a portion of the mark portion.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic plan view of an emblem member according to an embodiment.

FIG. 2 is a schematic cross section taken along a line II-II indicated in FIG. 1.

FIG. 3 is a schematic cross section taken along a line indicated in FIG. 1.

FIG. 4 is a schematic cross section taken along a line Iv-Iv indicated in FIG. 1.

FIG. 5 is a schematic diagram for illustrating a configuration of a connecting portion of the emblem member of FIG. 1.

FIG. 6 is a schematic diagram for illustrating an exemplary variation of the connecting portion in the emblem member of FIG. 1.

FIG. 7 is a schematic cross section of a yarn of embroidery forming a mark portion in the emblem member of FIG. 1.

FIG. 8 is a schematic cross section showing an exemplary variation of the yarn of the embroidery forming the mark portion in the emblem member of FIG. 1.

FIG. 9 is a flowchart of a method for manufacturing the emblem member of FIG. 1.

FIG. 10 is a flowchart for describing details of the step of forming a transparent member indicated in FIG. 9.

FIG. 11 is a flowchart for describing an exemplary variation of the step of forming the transparent member indicated in FIG. 9.

FIG. 12 is a schematic cross section of an emblem member manufactured in the method indicated in FIG. 11.

FIG. 13 is a schematic cross section showing a first exemplary variation of the emblem member shown in FIG. 1.

FIG. 14 is a schematic cross section showing a second exemplary variation of the emblem member shown in FIG. 1.

FIG. 15 is a schematic cross section showing a third exemplary variation of the emblem member shown in FIG. 1.

FIG. 16 is a schematic cross section showing a fourth exemplary variation of the emblem member shown in FIG. 1.

FIG. 17 is a schematic cross section showing a fifth exemplary variation of the emblem member shown in FIG. 1.

FIG. 18 is a schematic cross section showing a sixth exemplary variation of the emblem member shown in FIG. 1.

FIG. 19 is a schematic cross section showing a seventh exemplary variation of the emblem member shown in FIG. 1.

FIG. 20 is a schematic cross section showing an eighth exemplary variation of the emblem member shown in FIG. 1.

FIG. 21 is a schematic view of a ball catching tool with the FIG. 1 emblem member attached thereto.

### DESCRIPTION OF THE PREFERRED EMBODIMENTS

Hereinafter, an embodiment of the present disclosure will be described. Identical components are identically denoted and will not be described repeatedly.

<Configuration of Emblem Member>

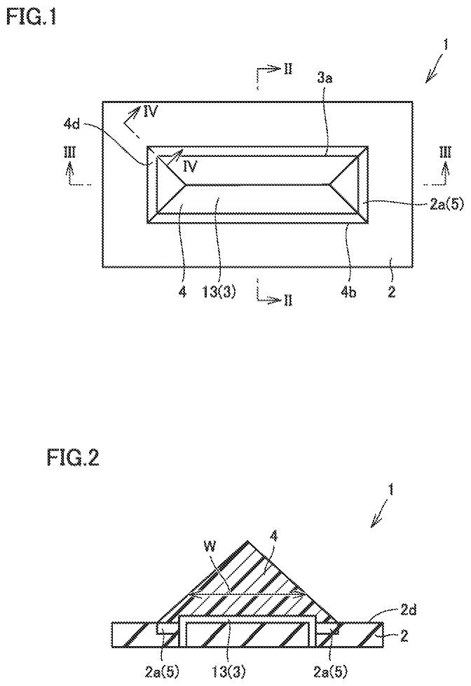

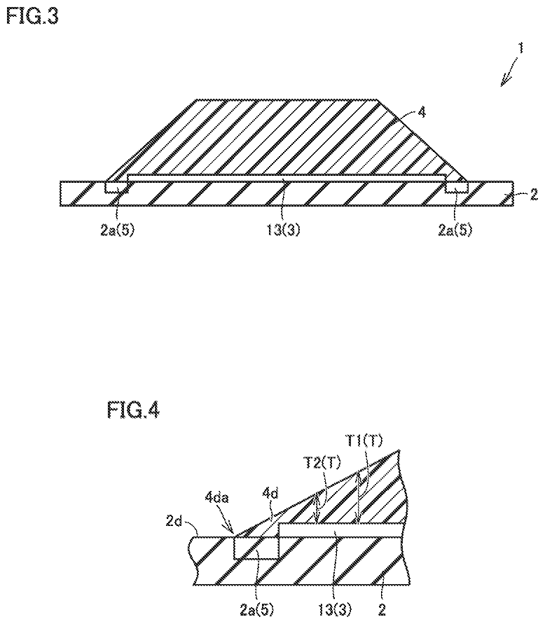

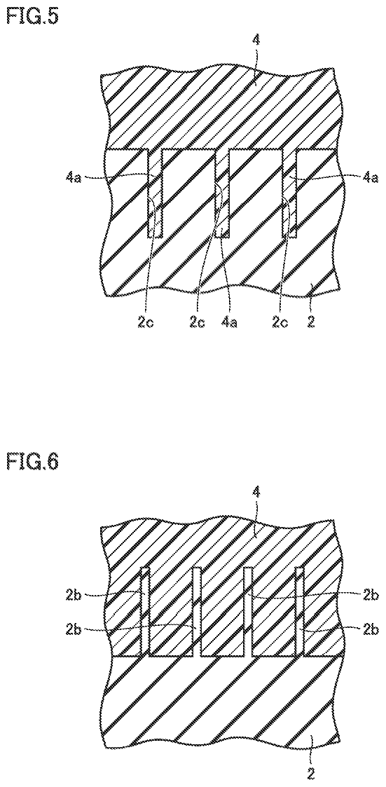

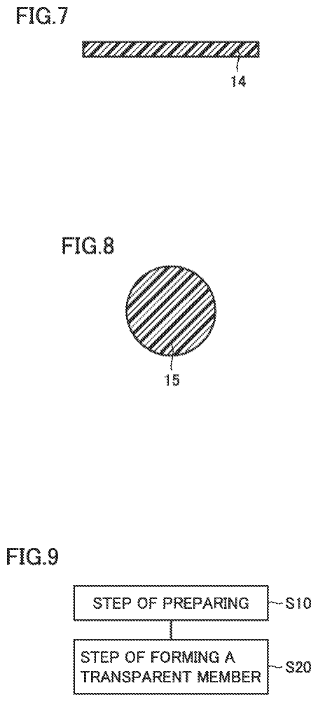

FIG. 1 is a schematic plan view of an emblem member according to an embodiment. FIG. 2 is a schematic cross section taken along a line II-II indicated in FIG. 1. FIG. 3 is a schematic cross section taken along a line indicated in FIG. 1. FIG. 4 is a schematic cross section taken along a line IV-IV indicated in FIG. 1. FIG. 5 is a schematic diagram for illustrating a configuration of a connecting portion of the emblem member of FIG. 1. FIG. 6 is a schematic diagram for illustrating an exemplary variation of the connecting portion in the emblem member of FIG. 1. FIG. 7 is a schematic cross section of a yarn of embroidery forming a mark portion in the emblem member of FIG. 1. FIG. 8 is a schematic cross section showing an exemplary variation of the yarn of the embroidery forming the mark portion in the emblem member of FIG. 1.

As shown in FIGS. 1 to 5, an emblem member 1 according to the present disclosure comprises a base portion 2, a mark portion 3, and a transparent member 4. Base portion 2 is a flat plate-shaped member. Base portion 2 may be made of any material, such as felt, cloth, leather, or synthetic leather. Mark portion 3 is formed on a surface 2d of base portion 2.

Mark portion 3 is configured for example by embroidery 13 formed by sewing through base portion 2 with a yarn. A pattern printed on the surface of base portion 2 may be used as mark portion 3. Emblem member 1 shown in FIG. 1 has mark portion 3 in the form of a quadrangle in plan view. Mark portion 3 in plan view may have any other shape such as a triangle, a polygon, a letter, or a logo mark. Mark portion 3 is provided with embroidery throughout a region surrounded by a contour line shown in FIG. 1. That is, mark portion 3 has its surface entirely covered with embroidery 13.

Transparent member 4 is disposed so as to cover mark portion 3. Transparent member 4 is connected to base portion 2 at a connecting portion 5 located at a periphery of mark portion 3. That is, as shown in FIG. 1, in a plan view in which surface 2d of base portion 2 is seen in a direction perpendicular to surface 2d of base portion 2, transparent member 4 has a periphery 4b along a periphery 3a of mark portion 3. Periphery 4b of transparent member 4 is disposed so as to externally surround periphery 3a of mark portion 3. A region located between periphery 3a of mark portion 3 and periphery 4b of transparent member 4 is connecting portion 5. How connecting portion 5 is configured will be described hereinafter.

As shown in FIG. 2, transparent member 4 has a triangular shape in one cross section. That is, in a cross section of transparent member 4 in the direction perpendicular to surface 2d of base portion 2, a width W of transparent member 4 in a direction along surface 2d of base portion 2 is smaller as the width is farther away from base portion 2. In this cross section, transparent member 4 has a side wall inclined with respect to surface 2d of base portion 2.

Further, as shown in FIG. 3, transparent member 4 has a trapezoidal shape in another cross section. In this cross section, transparent member 4 has a top surface extending in the direction along surface 2d of base portion 2. As shown in FIG. 1, transparent member 4 includes a corner portion 4d. Corner portion 4d projects in the direction along surface 2d of base portion 2. Transparent member 4 shown in FIG. 1 has four corner portions 4d. As shown in FIG. 4, transparent member 4 is smaller in thickness T as it approaches a tip 4da of corner portion 4d. That is, at corner portion 4d, a thickness T1 of a first portion of transparent member 4 is larger than a thickness T2 of a second portion of transparent member 4 located closer to tip 4da of corner portion 4d than the first portion.

While corner portion 4d of transparent member 4 shown in FIG. 4 has an upper end in a straight line, the upper end may be curved. The upper end may be in a curved line concaved toward base portion 2, or may be in a curved line convexed in a direction away from base portion 2. Alternatively, the upper end may include a curved line portion concaved toward base portion 2 and a curved line portion convexed in the direction away from base portion 2.

Transparent member 4 may be made of any material, for example, resin such as silicone resin. Transparent member 4 formed of a transparent or semi-transparent material suffices. Herein, being “semi-transparent” means having a transmittance less than 100 for visible light and still allowing mark portion 3 to be visually recognized through transparent member 4. For example, transparent member 4 having a transmittance of 40% or more for visible light suffices. A semi-transparent and colored material may be used as a material for transparent member 4.

As shown in FIG. 5, connecting portion 5 has a structure in which transparent member 4 has a portion 4a entering and fixed in a gap 2c formed in a surface of base portion 2. When a fibrous material such as felt is used as base portion 2, gap 2c between fibers is present in the surface of base portion 2. Transparent member 4 is fixed to base portion 2 as transparent member 4 has portion 4a solidified while gap 2c is impregnated therewith. Further, as embroidery 13 is used as mark portion 3, a gap between a yarn constituting embroidery 13 and surface 2d of base portion 2 and a gap between the yarn and another such yarn are also impregnated with a portion of transparent member 4 and the portion of transparent member is solidified. As a result, transparent member 4 is connected to base portion 2 and mark portion 3.

As a structure of connecting portion 5, as shown in FIG. 6, base portion 2 may have a portion 2b projecting toward and also buried in transparent member 4. As portion 2b of base portion 2, for example, fibers projecting from surface 2d of base portion 2 can be used. Connecting portion 5 having such a configuration also increases an area of a connection interface between base portion 2 and transparent member 4, and can firmly fix base portion 2 and transparent member 4 together. Transparent member 4 connected to base portion 2 so as to cover at least a portion of mark portion 3 suffices. That is, transparent member 4 may cover a portion of mark portion 3 and also be connected to base portion 2 by connecting portion 5.

A flat yarn 14 having a cross section as shown in FIG. 7 is used as a yarn constituting embroidery 13 as mark portion 3. Flat yarn 14 is preferably a flat yarn made of glossy resin. As a yarn constituting embroidery 13, a yarn 15 having a round cross section as shown in FIG. 8 or a yarn having another cross section may be used.

<Function>

Emblem member 1 according to the present disclosure comprises base portion 2, mark portion 3, and transparent member 4. Base portion 2 has surface 2d. Mark portion 3 is formed on surface 2d of base portion 2. Transparent member 4 is connected to base portion 2 so as to cover at least a portion of mark portion 3. In this case, mark portion 3 can be visually recognized through transparent member 4, and transparent member 4 can have a three-dimensional shape determined independently of the shape and material(s) of mark portion 3. This can provide an increased degree of freedom in designing emblem member 1.

For emblem member 1, connecting portion 5 between base portion 2 and transparent member 4 may include at least one of a first structure and a second structure. In the first structure, base portion 2 has portion 2b projecting toward and also buried in transparent member 4. In the second structure, transparent member 4 has portion 4a entering and fixed in gap 2c formed in a surface of base portion 2. In this case, base portion 2 and transparent member 4 can be fixed together by connecting portion 5. By adopting connecting portion 5 having such a configuration, a material which is difficult to be directly bonded to base portion 2 can be selected as a material for transparent member 4. This can provide a farther increased degree of freedom in designing emblem member 1.

For emblem member 1, mark portion 3 may include embroidery 13 provided on a surface of base portion 2. In this case, by visually recognizing mark portion 3 that is composed of embroidery 13 through transparent member 4, emblem member 1 different in designability from an emblem member composed of embroidery 13 alone can be implemented.

For emblem member 1, flat yarn 14 as a yarn constituting embroidery 13 may have a rectangular cross section. When this is compared with embroidery 13 composed of a yarn having a round cross section, the former can provide embroidery 13 as mark portion 3 with a change in texture. As a result, emblem member 1 can be enhanced in designability.

For emblem member 1, yarn 15 constituting embroidery 13 may have a round cross section. This allows embroidery 13 as mark portion 3 to generally have a smooth and uniform texture.

For emblem member 1, in a plan view in which surface 2d of base portion 2 is seen in a direction perpendicular to surface 2d of base portion 2, transparent member 4 may have periphery 4b along periphery 3a of mark portion 3. In this case, transparent member 4 having a shape along that of mark portion 3 in plan view can be obtained.

For emblem member 1, in plan view, periphery 4b of transparent member 4 may be outer than periphery 3a of mark portion 3. In this case, transparent member 4 is disposed so as to cover a surface of mark portion 3 entirely. Therefore, a visual effect through visual recognition through transparent member 4 can be obtained throughout mark portion 3.

For emblem member 1, in a cross section of transparent member 4 in the direction perpendicular to surface 2d of base portion 2, width W of transparent member 4 in the direction along surface 2d of base portion 2 may be smaller as the width is farther away from base portion 2. In this case, transparent member 4 has a side surface inclined with respect to surface 2d of base portion 2, and mark portion 3 is easily visually recognizable through transparent member 4.

For emblem member 1, transparent member 4 may include corner portion 4d. Corner portion 4d may project in the direction along surface 2d of base portion 2. Transparent member 4 may be smaller in thickness T as it approaches tip 4da of corner portion 4d. In this case, transparent member 4 is in the form of a wedge decreasing in width and height as corner portion 4d of transparent member 4 approaches tip 4da. When this is compared with adopting a simple shape such as a cube as a shape of transparent member 4, the former can enhance emblem member 1 in designability.

<Method for Manufacturing Emblem Member>

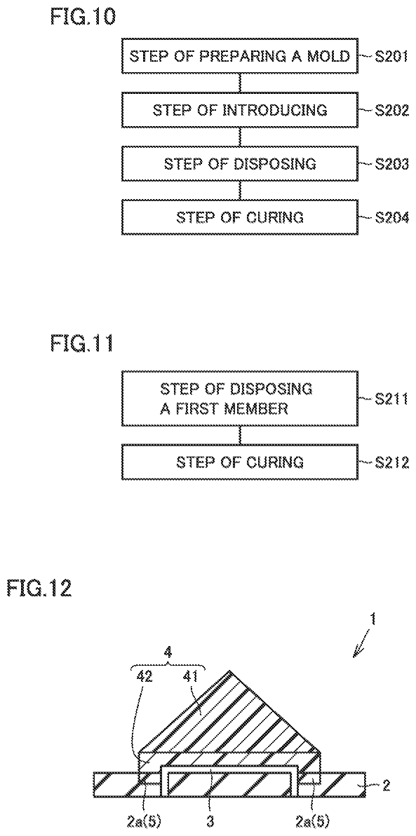

FIG. 9 is a flowchart of a method for manufacturing the emblem member of FIG. 1. FIG. 10 is a flowchart for describing details of the step of forming a transparent member indicated in FIG. 9. As shown in FIGS. 9 and 10, the method for manufacturing an emblem member comprises the step of preparing (S10) and the step of forming a transparent member (S20).

In step (S10), base portion 2 having surface 2d with mark portion 3 formed thereon is prepared. In step (S20), transparent member 4 is connected to base portion 2. Transparent member 4 is connected to base portion 2 so as to cover at least a portion of mark portion 3. Hereinafter, step (S20) will be described in detail.

As shown in FIG. 10, step (S20) includes the step of preparing a mold (S201), the step of introducing resin (S202), the step of disposing (S203), and the step of curing (S204). Specifically, initially, the step of preparing a mold (S201) is performed. In step (S201), a mold in which a recess that defines an external shape of transparent member 4 is formed is prepared. Any conventionally well-known material can be used as a material for the mold.

Subsequently, the step of introducing resin (S202) is performed. In step (S202), resin to be transparent member 4 is introduced into the recess of the mold. The resin is preferably in the form of liquid.

Subsequently, the step of disposing (S203) is performed. In step (S203), base portion 2 is disposed to come into contact with the resin introduced in the recess of the mold. In doing so, that surface of base portion 2 which has mark portion 3 formed thereon comes into contact with the resin.

Subsequently, the step of curing (S204) is performed. In step (S204), the resin in contact with base portion 2 is cured. As a result, the cured resin becomes transparent member 4. Transparent member 4 has been connected to base portion 2. Thereafter, an emblem member having transparent member 4 and base portion 2 integrated together is removed from the mold. In this way, the emblem member can be manufactured.

<Function>

The method for manufacturing an emblem member according to the present disclosure comprises the step of preparing (S10) and the step of forming (S20). In the step of preparing (S10), base portion 2 having surface 2d with mark portion 3 formed thereon is prepared. In the step of forming (S20), transparent member 4 connected to base portion 2 is formed so as to cover at least a portion of mark portion 3. Thus, the emblem member according to the present embodiment can be obtained.

In the method for manufacturing an emblem member, the step of forming (S20) may include the step of preparing a mold (S201), the step of introducing resin (S202), the step of disposing (S203), and the step of curing (S204). In the step of preparing a mold (S201), a mold in which a recess that defines an external shape of transparent member 4 is formed may be prepared. In the step of introducing resin (S202), resin to be transparent member 4 may be introduced into the recess of the mold. In the step of disposing (S203), base portion 2 may be disposed to come into contact with the resin. In the step of curing (S204) as the step of forming the transparent member, the resin in contact with base portion 2 may be cured.

In this case, in the step of curing (S204) to cure the resin in order to form transparent member 4, transparent member 4 can be connected to base portion 2 by solidifying the resin while the resin has a portion in contact with base portion 2.

<Exemplary Variation of Method for Manufacturing Emblem Member>

FIG. 11 is a flowchart for describing an exemplary variation of the step of forming the transparent member indicated in FIG. 9. FIG. 12 is a schematic cross section of an emblem member manufactured in the method indicated in FIG. 11.

An exemplary variation of the method for manufacturing the emblem member basically comprises the same process as the method for manufacturing the emblem member shown in FIG. 9 except for specifics of step (S20). That is, as shown in FIG. 11, in the exemplary variation of the method for manufacturing the emblem member, the step of forming the transparent member (S20) includes the step of disposing a first member (S211) and the step of curing (S212).

In the exemplary variation of the method for manufacturing the emblem member, after the step of preparing (S10) shown in FIG. 9 is performed, the step of disposing the first member (S211) in step (S20) is performed. In this step (S211), a first member 41 (see FIG. 12) to be transparent member 4 is disposed via an adhesive layer 42 (see FIG. 12) on surface 2d of base portion 2 on which mark portion 3 is formed. First member 41 and adhesive layer 42 are disposed on mark portion 3 of base portion 2. A paste adhesive is used as adhesive layer 42. Adhesive layer 42 is an adhesive which becomes transparent or semi-transparent after it is cured. Adhesive layer 42 may be formed of any conventionally well-known adhesive that can stick first member 41 and base portion 2 together.

First member 41 is a member constituting a portion of transparent member 4, and is composed of a transparent or semi-transparent member. First member 41 is previously shaped so as to be a portion of a final shape of transparent member 4.

Subsequently, the step of curing (S212) is performed. In step (S212), adhesive layer 42 is cured. Base portion 2 is impregnated with a portion of adhesive layer 42. As a result, connecting portion 5 (see FIG. 12) is formed when adhesive layer 42 is cured. Further, adhesive layer 42 cured (see FIG. 12) serves as a portion of transparent member 4. Thus, first member 41 and adhesive layer 42 cured constitute transparent member 4. Thus, emblem member 1 shown in FIG. 12 is obtained.

When the adhesive forming adhesive layer 42 has good adhesion to base portion 2, base portion 2 may not be impregnated with a portion of adhesive layer 42 and adhesive layer 42 may directly adhere to surface 2d of base portion 2. Further, when adhesive layer 42 exhibits good adhesion to a material constituting mark portion 3, adhesive layer 42 and base portion 2 may not be directly connected together outside mark portion 3.

<Function>

For emblem member 1, connecting portion 5 may include adhesive layer 42 cured. In this case, the process for manufacturing emblem member 1 can be simplified by using an adhesive.

<Configuration and Function of Variation of Emblem Member>

FIGS. 13 to 20 show an exemplary variation of the emblem member shown in FIG. 1. FIGS. 13 to 20 each correspond to FIG. 2. Hereinafter, exemplary variations of the emblem member will be described.

FIG. 13 is a schematic cross section showing a first exemplary variation of the emblem member shown in FIG. 1. Emblem member 1 shown in FIG. 13 basically has the same configuration as emblem member 1 shown in FIG. 1 except that how connecting portion 5 is configured and a coating layer 6 is further comprised. That is, for the emblem member shown in FIG. 13, surface 2d of base portion 2 includes a first region 2da and a second region 2db. First region 2da is a region in which transparent member 4 is disposed so as to cover mark portion 3. Second region 2db is a region other than first region 2da. Second region 2db surrounds first region 2da. Emblem member 1 includes coating layer 6 disposed so as to cover second region 2db. Coating layer 6 is connected to transparent member 4. Coating layer 6 is composed of a material similar to that of transparent member 4. Connecting portion 5 is an impregnated portion 2a at which base portion 2 is impregnated with a portion of transparent member 4 and coating layer 6 and the portion is solidified, and connecting portion 5 extends from a region under a peripheral portion of transparent member 4 to a region under coating layer 6. Connecting portion 5 is formed throughout a region located under coating layer 6.

Such a configuration can also provide an effect similar to that of the emblem member shown in FIG. 1. Further, coating layer 6 that covers second region 2db of base portion 2 functions as a protective member for protecting base portion 2. This can enhance emblem member 1 in durability.

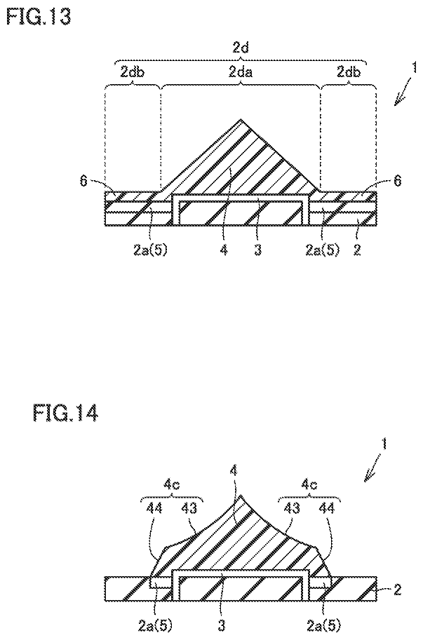

FIG. 14 is a schematic cross section showing a second exemplary variation of the emblem member shown in FIG. 1. Emblem member 1 shown in FIG. 14 basically has the same configuration as emblem member 1 shown in FIG. 1 except that transparent member 4 has a shape different than emblem member 1 shown in FIG. 1. That is, for emblem member 1 shown in FIG. 14, transparent member 4 has a surface 4c including a curved surface portion 43. Curved surface portion 43 is a curved surface convexed toward base portion 2. Further, surface 4c of transparent member 4 includes curved surface portion 43 described above and an inclined portion 44. Inclined portion 44 interconnects curved surface portion 43 and surface 2d of base portion 2. Inclined portion 44 is inclined away from mark portion 3 as inclined portion 44 approaches surface 2d of base portion 2. While inclined portion 44 has a flat surface, it may have a curved surface. Such a configuration can also provide an effect similar to that of emblem member 1 shown in FIG. 1. Further, as transparent member 4 has surface 4c including differently shaped portions, that is, curved surface portion 43 and inclined portion 44, how mark portion 3 is visually recognized through transparent member 4 can be significantly changed depending on the position of the line of sight.

FIG. 15 is a schematic cross section showing a third exemplary variation of the emblem member shown in FIG. 1. Emblem member 1 shown in FIG. 15 basically has the same configuration as emblem member 1 shown in FIG. 1 except that transparent member 4 has a shape different than emblem member 1 shown in FIG. 1. That is, for emblem member 1 shown in FIG. 15, transparent member 4 has surface 4c that is curved surface portion 43. Curved surface portion 43 is a curved surface convexed toward base portion 2. Such a configuration can also provide an effect similar to that of emblem member 1 shown in FIG. 1. Further, as transparent member 4 has surface 4c that is curved surface portion 43, how mark portion 3 is visually recognized through transparent member 4 can be significantly changed from how mark portion 3 is visually recognized through transparent member 4 when surface 4c is a flat surface.

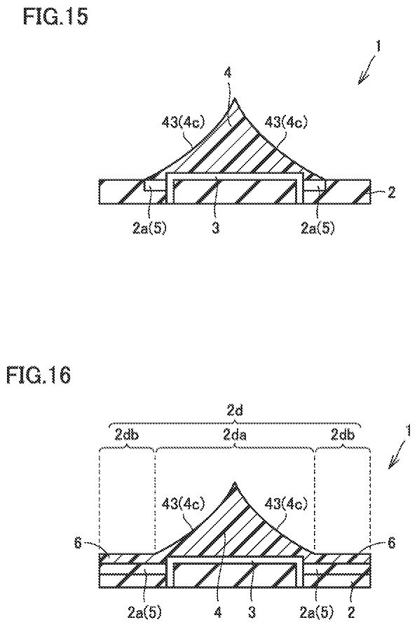

FIG. 16 is a schematic cross section showing a fourth exemplary variation of the emblem member shown in FIG. 1. Emblem member 1 shown in FIG. 16 basically has the same configuration as emblem member 1 shown in FIG. 15 except that how connecting portion 5 is configured and coating layer 6 is further comprised. That is, for the emblem member shown in FIG. 16, surface 2d of base portion 2 includes first region 2da and second region 2db. First region 2da is a region in which transparent member 4 is disposed. Second region 2db is a region other than first region 2da and surrounds first region 2da. Emblem member 1 includes coating layer 6 disposed so as to cover second region 2db. Coating layer 6 is connected to transparent member 4. Coating layer 6 is composed of a material similar to that of transparent member 4. Connecting portion 5 is an impregnated portion 2a at which base portion 2 is impregnated with a portion of transparent member 4 and coating layer 6 and the portion is solidified, and connecting portion 5 extends from a region under a peripheral portion of transparent member 4 to a region under coating layer 6. Connecting portion 5 is formed throughout a region located under coating layer 6. The configuration of coating layer 6 and connecting portion 5 of the emblem member shown in FIG. 16 is the same as the configuration of coating layer 6 and connecting portion 5 of emblem member 1 shown in FIG. 13. Such a configuration can provide an effect similar to that of emblem members 1 shown in FIGS. 15 and 13.

FIG. 17 is a schematic cross section showing a fifth exemplary variation of the emblem member shown in FIG. 1. Emblem member 1 shown in FIG. 17 basically has the same configuration as emblem member 1 shown in FIG. 1 except that transparent member 4 has a shape different than emblem member 1 shown in FIG. 1. That is, for emblem member 1 shown in FIG. 17, transparent member 4 has surface 4c that is a curved surface portion 45. Curved surface portion 45 is a curved surface convexed in a direction away from base portion 2. Such a configuration can also provide an effect similar to that of emblem member 1 shown in FIG. 1. Further, as transparent member 4 has surface 4c that is curved surface portion 45, how mark portion 3 is visually recognized through transparent member 4 can be significantly changed from how mark portion 3 is visually recognized through transparent member 4 when surface 4c is a flat surface. Further, transparent member 4 shown in FIG. 17 can also act like a convex lens to enlarge mark portion 3 for visual recognition.

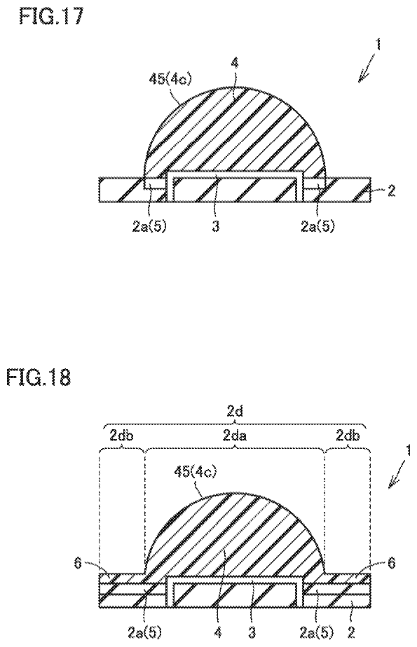

FIG. 18 is a schematic cross section showing a sixth exemplary variation of the emblem member shown in FIG. 1. Emblem member 1 shown in FIG. 18 basically has the same configuration as emblem member 1 shown in FIG. 17 except that the former comprises connecting portion 5 and coating layer 6. That is, the emblem member shown in FIG. 18 comprises coating layer 6 and connecting portion 5 similar to those of emblem member 1 shown in FIG. 16. Such a configuration can provide an effect similar to that of emblem members 1 shown in FIGS. 17 and 16.

FIG. 19 is a schematic cross section showing a seventh exemplary variation of the emblem member shown in FIG. 1. Emblem member 1 shown in FIG. 19 basically has the same configuration as emblem member 1 shown in FIG. 1 except that transparent member 4 has a shape different than emblem member 1 shown in FIG. 1. That is, for emblem member 1 shown in FIG. 19, transparent member 4 has an upper portion that is a flat surface. That is, transparent member 4 has a trapezoidal cross section. Such a configuration can also provide an effect similar to that of emblem member 1 shown in FIG. 1. Further, as transparent member 4 has a trapezoidal cross section, how mark portion 3 is visually recognized through transparent member 4 can be significantly changed from how mark portion 3 is visually recognized for emblem member 1 shown in FIG. 1.

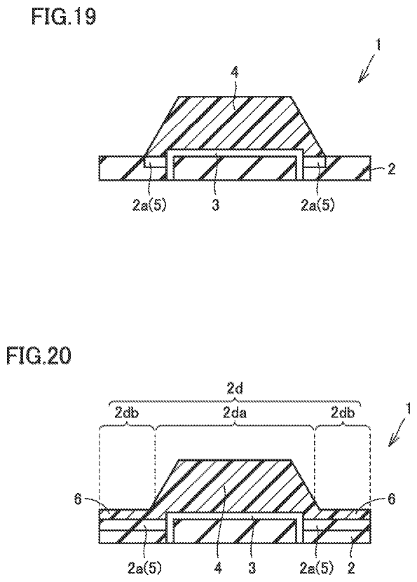

FIG. 20 is a schematic cross section showing an eighth exemplary variation of the emblem member shown in FIG. 1. Emblem member 1 shown in FIG. 20 basically has the same configuration as emblem member 1 shown in FIG. 19 except that the former comprises connecting portion 5 and coating layer 6. That is, the emblem member shown in FIG. 20 comprises coating layer 6 and connecting portion 5 similar to those of emblem member 1 shown in FIG. 16. Such a configuration can provide an effect similar to that of emblem members 1 shown in FIGS. 19 and 16.

<Example of Exercise Tool with Emblem Member Applied Thereto>

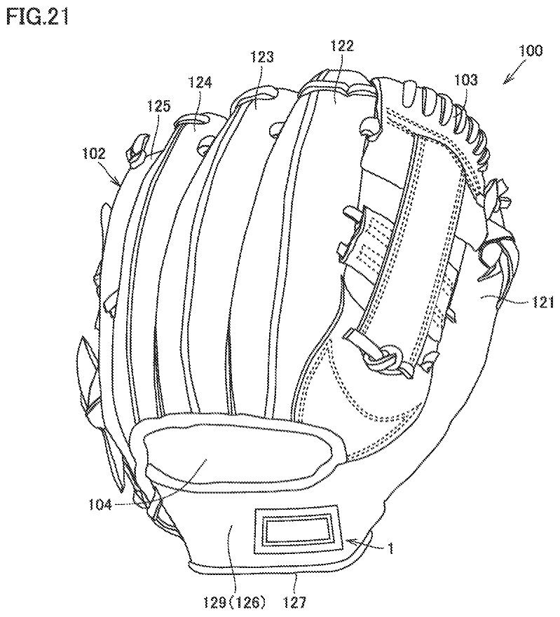

FIG. 21 is a schematic view of a ball catching tool with the FIG. 1 emblem member attached thereto. As shown in FIG. 21, a baseball or softball ball catching tool 100 (hereinafter simply referred to as ball catching tool 100) which is an example of an exercise tool according to the present embodiment is worn by a wearer's hand. In the following description, a wearer's hand includes a bare hand or a hand wearing a glove (an underglove). A back of a hand of a wearer includes a back of a bare hand or an outermost surface portion of a hand located on the back side of a glove. Further, while the present embodiment indicates a baseball or softball glove as an example of ball catching tool 100, ball catching tool 100 in the present embodiment may be a catcher's mitt, a first baseman's mitt, or the like.

Ball catching tool 100 mainly comprises a bag portion 102, a web portion 103, and emblem member 1. Bag portion 102 has an internal space for receiving the wearer's hand. Bag portion 102 and web portion 103 are mainly composed of a material such as for example natural leather, artificial leather, synthetic leather, or the like.

Bag portion 102 includes, for example, a first finger bag portion 121, a second finger bag portion 122, a third finger bag portion 123, a fourth finger bag portion 124, a fifth finger bag portion 125, and a palm bag portion 126. First, second, third, fourth and fifth finger bag portions 121, 122, 123, 124 and 125 are connected to palm bag portion 126.

First finger bag portion 121 has an internal space provided for receiving a first finger (a thumb) of the wearer. Second finger bag portion 122 has an internal space provided for receiving a second finger (an index finger) of the wearer. Third finger bag portion 123 has an internal space provided for receiving a third finger (a middle finger) of the wearer. Fourth finger bag portion 124 has an internal space provided for receiving a fourth finger (a ring finger) of the wearer. Fifth finger bag portion 125 has an internal space provided for receiving a fifth finger (a little finger) of the wearer. Palm bag portion 126 has an internal space provided for receiving a palm of the wearer. The internal space of the palm bag portion 126 receives the wear's first metacarpal bone (the metacarpal bone of a thumb), a second metacarpal bone (the metacarpal bone of an index finger), a third metacarpal bone (the metacarpal bone of a middle finger), a fourth metacarpal bone (the metacarpal bone of a ring finger), and a fifth metacarpal bone (the metacarpal bone of a little finger).

First, second, third, fourth and fifth finger bag portions 121, 122, 123, 124, and 125 have their respective internal spaces connected to the internal space of palm bag portion 126. First, second, third, fourth and fifth finger bag portions 121, 122, 123, 124 and 125 have their respective internal spaces interconnected via the internal space of palm bag portion 126.

First finger bag portion 121 is distant from second, third, fourth and fifth finger bag portions 122, 123, 124 and 125. First finger bag portion 121 and second finger bag portion 122 are disposed with web portion 103 interposed. Third finger bag portion 123 is disposed adjacent to second finger bag portion 122 on a side opposite to first finger bag portion 121 with respect to second finger bag portion 122. Fourth finger bag portion 124 is disposed adjacent to third finger bag portion 123 on a side opposite to second finger bag portion 122 with respect to third finger bag portion 123. Fifth finger bag portion 125 is disposed adjacent to fourth finger bag portion 124 on a side opposite to third finger bag portion 123 with respect to fourth finger bag portion 124.

Palm bag portion 126 includes an insertion portion 127, a palm portion (not shown), and a back portion 129. Insertion portion 127 is configured as an opening for the wearer to insert a hand into the internal space of ball catching tool 100. Insertion portion 127 faces the internal space of palm bag portion 126 and is located on a side opposite to the internal space of each of first, second, third, fourth and fifth finger bag portions 121, 122, 123, 124 and 125 with respect to the internal space of palm bag portion 126.

The palm portion is disposed so as to face a palm of the wearer. The palm portion faces the internal space of palm bag portion 126 and is located on the side of the palm of the wearer with respect to the internal space of palm bag portion 126.

Back portion 129 is disposed so as to face the back of a hand of the wearer. Back portion 129 faces the internal space of palm bag portion 126 and is disposed on the side of the back of the hand of the wearer with respect to the internal space of palm bag portion 126. Back portion 129 is provided so as to face at least the second, third, fourth and fifth metacarpal bones of the wearer. Back portion 129 is composed for example of a strap. A portion of back portion 129 located on the side of the thumb is provided such that it is integrated for example with a portion of bag portion 102 located on the side of the thumb. A portion of back portion 129 located on the side of the little finger is connected for example by a string member to a portion of bag portion 102 located on the side of the little finger.

Bag portion 102 between back portion 129 and second to fourth finger bag portions 122-124 is provided for example with an opening 104. Opening 104 faces the internal space of bag portion 102. Back portion 129 is disposed closer to insertion portion 127 than opening 104 is, for example.

Web portion 103 is attached to bag portion 102. Web portion 103 is disposed between first finger bag portion 121 and second finger bag portion 122. Web portion 103 is configured to cover at least a portion of a region located between first finger bag portion 121 and second finger bag portion 122. Web portion 103 is provided in the form of a mesh, for example. Web section 103 is not limited in configuration thereto.

As shown in FIG. 21, emblem member 1 is attached to back portion 129. Emblem member 1 may be attached to either a surface of bag portion 102 or a surface of web portion 103. For example, emblem member 1 may be disposed on any of first, second, third, fourth and fifth finger bag portions 121, 122, 123, 124 and 125 on a back side thereof. Alternatively, emblem member 1 may be disposed on web portion 103 on a back side thereof.

It should be understood that the presently disclosed embodiments are illustrative and non-restrictive in any respect. At least two of the presently disclosed embodiments may be combined together unless doing so is contradictory. The present disclosure basically has a scope defined by the appended claims rather than by the foregoing description, and is intended to include any modification within the meaning and scope equivalent to the terms of the appended claims.

What is claimed is:

1. An emblem member comprising:
a base portion having a surface;
a mark portion formed on the surface of the base portion; and
a transparent member connected to the base portion so as to cover at least a portion of the mark portion.

2. The emblem member according to claim 1, wherein a connecting portion of the base portion and the transparent member includes at least one of a first structure in which the base portion has a portion projecting toward and also buried in the transparent member and a second structure in which the transparent member has a portion entering and fixed in a gap formed in the surface of the base portion.

3. The emblem member according to claim 1, wherein the mark portion includes embroidery provided to the surface of the base portion.

4. The emblem member according to claim 3, wherein the embroidery is composed of a yarn having a rectangular cross section.

5. The emblem member according to claim 1, wherein, in a plan view of the surface of the base portion as seen in a direction perpendicular to the surface of the base portion, the transparent member has a periphery along a periphery of the mark portion.

6. The emblem member according to claim 5, wherein, in the plan view, the periphery of the transparent member is located outwardly of the periphery of the mark portion.

7. The emblem member according to claim 1, the surface of the base portion including a first region provided with the transparent member and a second region other than the first region, the emblem member further comprising a coating layer disposed to cover the second region.

8. The emblem member according to claim 1, wherein the transparent member has a surface including a curved surface portion.

9. The emblem member according to claim 8, wherein the transparent member has the surface with the curved surface portion including a curved surface convexed toward the base portion.

10. The emblem member according to claim 1, wherein, in a cross section of the transparent member in a direction perpendicular to the surface of the base portion, a width of the transparent member in a direction along the surface of the base portion is smaller as the width is farther away from the base portion.

11. The emblem member according to claim 1, wherein
the transparent member includes a corner portion projecting in a direction along the surface of the base portion; and
the transparent member is smaller in thickness as it approaches a tip of the corner portion.
